(19) United States
(12) Patent Application Publication
(10) Pub. No.: US 2007/0045284 A1
(43) Pub. Date: Mar. 1, 2007

(54) Control for a cooking device and method for controlling a cooking device

(75) Inventors: Katja Balk, Grabenstatt (DE); Hans Rogenhofer, Holzkirchen (DE); Michael Ulmer, Traunreut (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/571,159

(22) PCT Filed: Sep. 13, 2004
(86) PCT No.: PCT/EP04/10224

§ 371 Date: Mar. 8, 2006

(30) Foreign Application Priority Data
Sep. 12, 2003 (DE) 10342320.6

(51) Int. Cl. H05B 1/02

(52) U.S. Cl. 219/497

(57) ABSTRACT

A control and a method for controlling a cooking device, which is adapted to carry out cooking programs. The control includes a selection element for selecting a cooking program, a first input element for inputting the amount of cooking desired, a processing unit which modifies a parameter of the cooking program depending on the amount of cooking desired, the control controlling the cooking device in accordance with the cooking program modified by the parameter. The cooking program depends on a plurality of modifiable parameters and the processing unit determines from the plurality of parameters the parameters to be modified subject to the selected cooking program and/or subject to the adjusted amount of cooking.

The present invention relates to a control for a cooking device which is adapted to carry out cooking programs, comprising a selection element for selecting a cooking program, a first input element for inputting the amount of cooking, a processor unit which modifies a parameter of the cooking program depending on the amount of cooking, the control controlling the cooking device in accordance with the cooking program using the modified parameter, and a corresponding method for controlling a cooking device.

Such a control is known from DE 43 18 206 C2. Described therein is a microwave oven which is configured for carrying out automatic cooking programs. These automatic cooking programs have a function for adjusting the amount of cooking in which the user can adjust the amount of cooking in three stages during cooking. If a “high” button in the range of the amount of cooking adjustment button is pressed, the amount of cooking adjustment is intensified. Furthermore, by pressing a “low” button in the amount of cooking adjustment, the adjustment of the amount of cooking is reduced. If no buttons are pressed, the adjustment of the amount of cooking is standardised. In this case, the user merely needs to decide whether the food is to be cooked less or more than the preset amount of cooking.

The disadvantage of the control proposed in DE 43 18 206 C2 is firstly that only three stages can be selected for the amount of cooking. These three stages are frequently not sufficient to achieve the cooking result desired by the user for the food used using the selected automatic cooking program. Secondly, only one parameter, namely the microwave power is increased or reduced when adjusting the amount of cooking in DE 43 18 206 C2. In this way, the amount of cooking and therefore the cooking result can only be influenced to a limited extent.

A cooking device is known from DE 198 32 757 C2 in which a number of cooking programs are available from which a user can select one cooking program. Parameters of the cooking program which can be modified by the user such as the weight of food, temperature or duration of the cooking program are displayed on a display device of the cooking device. It is possible for the user to modify these parameters by means of input control elements and thereby influence the cooking result in accordance with their wishes. For this however, the user requires a knowledge of how the cooking result depends on these parameters of the cooking program.

It is the object of the invention to provide a control for a cooking device which is easy to handle and with which an improved cooking result can be achieved.

This object is solved by a control for a cooking device with the features of claim 1 and a method for controlling the cooking device with the features of claim 9.

The control for a cooking device is adapted to carry out cooking programs, comprising a selection element for selecting a cooking program, a first input element for inputting the amount of cooking and a processor unit which modifies a parameter of the cooking program depending on the amount of cooking. The control controls the cooking device in accordance with the cooking program using the modified parameter. The cooking program depends on a number of variable parameters and the processor unit determines from a plurality of parameters the parameters to be modified as a function of the selected cooking program and/or as a function of the adjusted amount of cooking. In particular, the processor unit modifies the parameters as a function of the cooking program and/or the degree of cooking in different ways.

In the method for controlling a cooking device a cooking program is selected and an amount of cooking is adjusted for the cooking program, depending on which a parameter of the cooking program is modified. The cooking device is controlled according to the cooking program using the modified parameter. The cooking program depends on a plurality of variable parameters and from the plurality of parameters the parameters to be modified are determined by the selected cooking program and/or by the set amount of cooking. In particular, the parameters are varied as a function of the cooking program and/or the amount of cooking in various ways.

In this way, for the same adjustment of the amount of cooking for different dishes different parameters of the allocated cooking programs or the same parameters can be modified in different ways. For a special dish therefore, by adjusting the amount of cooking it is possible to specifically modify those parameters of the cooking program which result in an optimised cooking result for the special dish at the adjusted amount of cooking. The user also has the advantage that they merely need to select the desired amount of cooking of the dish. No special knowledge is required as to how specific parameters influence the cooking result. Thus a cooking result in accordance with the wishes of the user is achieved by simple handling.

Advantageously the parameters for at least one time section of the cooking program are modified by the processor unit, especially the parameters for different time sections of the cooking program are modified differently. This is especially advantageous for dishes where at least one parameter varies in its allocated cooking program for the different time sections since in such a program the parameter for the different time sections can be modified differently with merely one adjustment of the amount of cooking so that an optimal cooking result is achieved. In addition, it is also possible for different parameters to be varied for different time sections.

According to a preferred embodiment it is provided that the control has a second input element for inputting a weight of food and that especially the processor unit modifies the parameters depending on the weight of food. Thus, for different quantities of food in a dish, parameters can be adapted differently in the same cooking program for the same adjustment of the amount of cooking in order to optimise the cooking result for the respective quantity of food.

In order to keep the adjustment effort for the user low, it is provided in a preferred embodiment that the control has a memory unit for storing the modified parameters pertaining to the cooking program and/or the amount of cooking pertaining to the cooking program so that if necessary the modified parameters pertaining to the cooking program and/or the adjusted amount of cooking can be stored. In this way for frequently used cooking programs the user can store the adjustment of the amount of cooking for the cooking result preferred by him so that this is preset when the cooking program is repeatedly called up and further adaptation of the amount of cooking is superfluous.

In particular, a program duration and/or a desired temperature and/or a heating power and/or a weight of food and/or an operating mode are modified by the processor unit as parameters. It is particularly advantageous if several parameters of the cooking program can be adapted since a particularly good result can be achieved in this manner. This is particularly successful if the operating modes used, such as overheat or underheat for example can be varied for the cooking program.

The control advantageously has a display unit for displaying, especially for numerical and/or graphical displays of the amount of cooking so that the adjustment of the amount of cooking is visible for the user. A bar display is particularly well suited where more or fewer light fields are illuminated depending on the adjustment of the amount of cooking.

In a preferred embodiment it is provided that the first input element for inputting the amount of cooking is a function key or a rotary switch. In particular, this first input element comprises a bit generator. In this way, the user can easily adjust the amount of cooking and as a result of the bit generator a large number of adjustment stages are possible for the amount of cooking so that it is possible for the user to adapt the cooking result especially well to his individual wishes.

In particular, the invention relates to a cooking device such as, for example, a cooker with a baking oven, a microwave device or a light wave oven.

The invention and its further developments are explained in detail hereinafter with reference to the drawings:

### IN THE FIGURES

FIG. 1 is a schematic diagram of a control according to the invention for a cooking device, and

FIG. 2 is an input panel for the control of the cooking device.

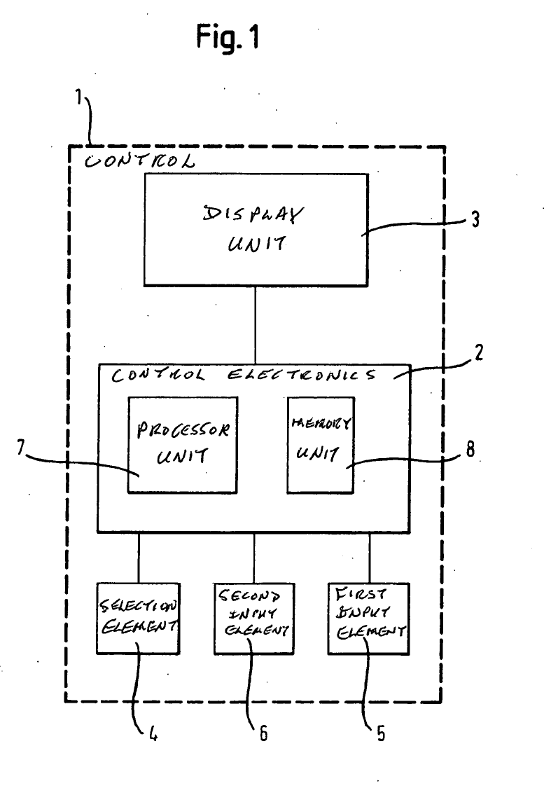

A control 1 according to the invention for a cooking device shown in FIG. 1 comprises control electronics 2 which are connected to a display unit 3, a selection element 4 for selecting a cooking program, a first input element 5 for inputting an amount of cooking and a second input element 6 for inputting a weight of food. The control electronics 2 furthermore has connections to the actuators of the cooking device such as, for example, various heating elements or a fan and connections to further input elements or sensors which are not shown here. The control electronics 2 comprises a processor unit 7 and a memory unit 8.

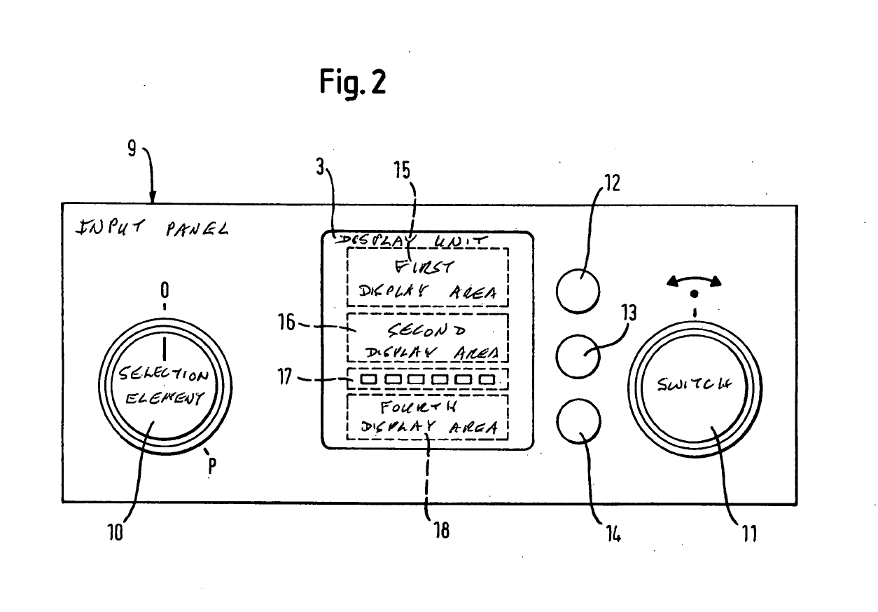

FIG. 2 shows an input panel 9 for the control 1 of the cooking device, comprising the display unit 3, a selection element 10 with a switch position P for activating an automatic program selection, a rotary switch 11 which comprises a bit generator, a confirmation element 12 for confirming a program selection, a memory button 13 for storing a selected setting and a weight button 14 for activating an input of a food weight. The display unit 3 is divided into a first display area 15, a second display area 16, a third display area 17 and a fourth display area 18.

A user sets the selection element 10 to the switch position P and thus activates the automatic program selection. Using the rotary switch 11 which can be turned in both directions in accordance with the directions of the arrow in FIG. 2, the user selects a cooking program for a dish where the designation of the respective dish is displayed in the first display area 15 of the display unit 3. The cooking program is selected by actuating the confirmation element 12. Alternatively, as shown in FIG. 1, a separate selection element 4 can be provided which can be used to select a cooking program. The cooking programs for selection are typically stored in the memory unit 8.

Input of the food weight can be activated by actuating the weight button 14. The food weight can be set using the rotary switch 11 and the set weight of food is displayed in the fourth display area 18 of the display device 3. If the correct food weight is entered, this can be confirmed by actuating the confirmation element 12. Alternatively, as shown in FIG. 1 a separate second input element 6 can be provided which can be used to enter the weight of food.

Within a predetermined time interval of ten seconds, for example, the user can now set the amount of cooking desired by turning the rotary switch 11. For this purpose the amount of cooking is displayed in the third display area 17 of the display device 3 in the form of a bar display where more or fewer light fields can be illuminated starting from left to right depending on the adjustment of the amount of cooking. If the rotary switch 11 is now turned in the clockwise direction, the amount of cooking is increased and more light fields light up whereas if the rotary switch 11 is turned anticlockwise, the amount of cooking is reduced and fewer light fields light up. Alternatively a numerical display of the amount of cooking can be selected where high numbers indicate a high amount of cooking and low numbers indicate a low amount of cooking. The selected amount of cooking can be confirmed by actuating the confirmation element 12 and stored by actuating the memory button 13. Alternatively, as shown in FIG. 1, a separate first input element 5 can be provided which can be used to enter the amount of cooking. The cooking program can be started by actuating the confirmation element 12 once again.

The series of different input steps by the user is an example. Different sequences can also be selected. Instead of confirming the respective input by actuating the confirmation element 12, a time interval can also be provided after which the input is considered to be confirmed. In this case, the second display area 16 of the display device 3 can be used to display the respectively active input step. For example, the text “amount of cooking” is displayed in the second display area 16 to request the setting of the amount of cooking.

After entering the amount of cooking and the weight of food, parameters of the selected cooking program are modified in the processor unit 7. In this case, it depends on the set amount of cooking and on the selected dish and thus on the selected cooking program which parameters are modified starting from the standard setting. For example, in a first cooking program merely either a program duration or a desired temperature are varied as parameters depending on whether the food is to be cooked more or less. In a second cooking program several parameters are varied depending on the input amount of cooking, such as, for example, program duration, desired temperature and heating power. A further parameter which can be varied according to the selected amount of cooking is an operating mode such as, for example, overheat, underheat, microwave or light waves. It is also possible that the parameters are merely varied for a time-limited section of the cooking program starting from the standard setting. For example, the overheat is switched on in the last five minutes of the cooking program or its heating power is increased in order to achieve a crusty surface of the food. Depending on the dish, i.e. depending on the selected cooking program, different parameters can also be varied for different time sections of the cooking program starting from the standard setting or the same parameters can be varied differently to achieve an optimal cooking result. It can also depend on the weight of food as to which parameters of a cooking program are varied according to the selected amount of cooking. Furthermore, the variation in the respective parameter can likewise depend on the weight of food. The weight of food itself can also be treated as a parameter which is varied according to the selected amount of cooking starting from the input weight of food.

As an example, the following table shows three adjustable amounts of cooking “cooking amount 1”, “cooking amount 2” and “cooking amount 3” for three cooking programs “program 1”, “program 2” and “program 3”. The program duration “D”, the desired temperature “T”, the heating power “L”, the food weight “G” and the operating mode “B” are provided as possible parameters which can be varied by entering the amount of cooking. The variation of the individual parameters in turn depends on the selected cooking program “PG1”, “PG2” or “PG3”, on the set amount of cooking “GG1”, “GG2” or “GG3” and possibly on the input weight of food “G”.

| | | | Program 3 | Program 3 | Program 3 |
|---|---|---|---|---|---|
| | Program 1 | Program 2 | A1 | A2 | A3 |
| Cooking | D(PG1, | L(PG2, | — | — | B(PG3, |
| amount 1 | GG1) | GG1), | | | GG1) |
| | | B(PG2, | | | |
| | | GG1) | | | |
| Cooking | D(PG1, | L(PG2, | D(PG3, | — | T(PG3, |
| amount 2 | GG2), | GG2), | GG2) | | GG2, G), |
| | T(PG1, | B(PG2, | | | B(PG3, |
| | GG2) | GG2) | | | GG2) |
| Cooking | B(PG1, | G(PG2, | D(PG3, | T(PG3, | T(PG3, |
| amount 3 | GG3) | GG3) | GG3) | GG3) | GG3, G) |
| | | | | | B(PG3, |
| | | | | | GG3) |

In the first cooking program “program 1”, for example the operating time “D”, the desired temperature “T” and the operating mode “B” can be varied starting from a standard setting. In the cooking amount setting “cooking amount 1” only the program duration “D(PG1, GG1)” is varied depending on the cooking program “PG1” and the cooking amount “GG1”. In the cooking amount setting “cooking amount 2” the program duration “D(PG1, GG2)” and the desired temperature “T(PG1, GG2)” are varied depending on the cooking program “PG1” and the cooking amount “GG2”. In the cooking amount setting “cooking amount 3” in the cooking program “program 1” only the operating mode “B(PG1, GG3)” is varied as a parameter depending on the cooking program “PG1” and the cooking amount “GG3”. The other parameters of the cooking program “program 1” each correspond to the standard setting.

In the second cooking program “program 2” for the cooking amount settings “cooking amount 1” and “cooking amount 2” the heating power “L” and the operating mode “B” are varied as parameters starting from a standard setting and depending on the cooking program “PG2” and the respective cooking amount “GG1” or “GG2”. For the cooking amount setting “cooking amount 3” the food weight “G” is treated as a parameter and is varied starting from the input food weight depending on the cooking program “PG2” and the cooking amount “GG3”.

In the third cooking program “program 3” the operating time “D”, the desired temperature “T” and the operating mode “B” can be varied as parameters starting from a standard setting. The third program “program 3” is divided into three time sections “A1”, “A2” and “A3”. For each of the time sections “A1”, “A2” and “A3” various parameters are varied depending on the cooking amount setting. In the cooking amount setting “cooking amount 1” the parameters for the time sections “A1” and “A2” correspond to the standard setting and for the third time section “A3” only the operating mode “B(PG3, GG1)” is varied depending on the cooking program “PG3” and the cooking amount “GG1”. In the cooking amount setting “cooking amount 2” the parameters only correspond to the standard setting for the time section “A2”. For the time section “A1” the program duration “D(PG3, GG2)” that is the duration of the time section “A1” itself is only varied depending on the cooking program “PG3” and the cooking amount “GG2”. For the time section “A3” the desired temperature “T(PG3, GG2, G)” and the operating mode “B(PG3, GG2)” are each varied depending on the cooking program “PG3” and the cooking amount “GG2”. The desired temperature “T(PG3, GG2, G)” is also varied depending on the weight of food “G”. In the cooking amount setting “cooking amount 3” the desired temperature “T(PG3, GG3)” is varied for the time section “A2” and for the time sections “A1” and “A3” the same parameters are varied as in the cooking amount setting “cooking amount 2” depending on the cooking program “PG3” and the cooking amount “GG3”.

The variation of a parameter can in turn be different according to the selected cooking program or according to the set amount of cooking. That is, if the parameter is calculated by the processor unit 7, for example, in the form of a function which depends on the selected cooking program and the set amount of cooking, this parameter can be different according to the cooking program or according to the amount of cooking, e.g., linear or nonlinear. Thus, in the above table for example, the program duration “D” for the time section “A1” of the cooking program “program 3” for the cooking amount setting “cooking amount 2” can be determined in a different fashion, as for the cooking amount setting “cooking amount 3”.

### REFERENCE LIST

1 Control
2 Control electronics
3 Display device
4 Selection element for selecting a cooking program
5 First input element for inputting a cooking amount
6 Second input element for inputting a weight of food
7 Processor unit
8 Memory unit
9 Input field
10 Selection element
11 Rotary switch with bit generator
12 Confirmation element
13 Memory button
14 Weight button
15 First display area
16 Second display area
17 Third display area
18 Fourth display area

1-22. (canceled)

23. A control for a cooking device which is adapted to carry out cooking programs, comprising:
a selection element for selecting a cooking program;
a first input element for inputting the amount of cooking;
a processor unit which modifies a parameter of said cooking program depending on the amount of cooking inputted;
the control controls the cooking device in accordance with said cooking program using said modified parameter;
said cooking program depends on a plurality of variable parameters; and
said processor unit selects the parameters to be varied from said plurality of parameters depending on at least one of said selected cooking program and said set amount of cooking.

24. The control according to claim 23, including said processor unit varies said parameters in different ways depending on at least one of said cooking program and said amount of cooking.

25. The control according to claim 23, including said processor unit varies said parameters for at least one time section of said cooking program.

26. The control according to claim 23, including said processor unit varies said parameters differently for different time sections of said cooking program.

27. The control according to claim 23, including said processor unit varies different parameters for different time sections of said cooking program.

28. The control according to claim 23, including said control has a second input element for inputting a weight of food and said processor unit varies said parameters depending on said input weight of food.

29. The control according to claim 23, including the control has a memory unit for storing said modified parameters relevant to at least one of said cooking program and said amount of cooking relevant to said cooking program.

30. The control according to claim 23, including said processor unit varies at least one of a program duration and a desired temperature and a heating power and a weight of food and an operating mode as parameters.

31. The control according to claim 23, including the control has a display unit for at least one of the numerical and graphical display of said amount of cooking.

32. The control according to claim 23, including said first input element is one of a function key or a rotary switch.

33. The control according claim 23, including said first input element has a bit generator.

34. A cooking device, comprising:
a control to carry out cooking programs including;
a selection element for selecting a cooking program;
a first input element for inputting the amount of cooking;
a processor unit which modifies a parameter of said cooking program depending on the amount of cooking inputted;
the control controls the cooking device in accordance with said cooking program using said modified parameter;
said cooking program depends on a plurality of variable parameters; and
said processor unit selects the parameters to be varied from said plurality of parameters depending on at least one of said selected cooking program and said set amount of cooking.

35. The cooking device according to claim 34, including said processor unit varies said parameters in different ways depending on at least one of said cooking program and said amount of cooking.

36. The cooking device according to claim 34, including said processor unit varies said parameters for at least one time section of said cooking program.

37. The cooking device according to claim 34, including said processor unit varies said parameters differently for different time sections of said cooking program.

38. The cooking device according to claim 34, including said processor unit varies different parameters for different time sections of said cooking program.

39. The cooking device according to claim 34, including said control has a second input element for inputting a weight of food and said processor unit varies said parameters depending on said input weight of food.

40. The cooking device according to claim 34, including the control has a memory unit for storing said modified parameters relevant to at least one of said cooking program and said amount of cooking relevant to said cooking program.

41. The cooking device according to claim 34, including said processor unit varies at least one of a program duration and a desired temperature and a heating power and a weight of food and an operating mode as parameters.

42. The cooking device according to claim 34, including the control has a display unit for at least one of the numerical and graphical display of said amount of cooking.

43. The cooking device according to claim 34, including said first input element is one of a function key or a rotary switch.

44. The cooking device according claim 34, including said first input element has a bit generator.

45. A method for controlling a cooking device, comprising:
selecting a cooking program;
setting an amount of cooking for said selected cooking program;
modifying a parameter of depending on said selected cooking program;
controlling the cooking device according to said selected cooking program with said modified parameter;
said cooking program depending on a plurality of variable parameters; and
determining said parameters to be varied from a plurality of parameters by at least one of said selected cooking program and said set amount of cooking.

46. The method according to claim 45, including varying said parameters in different ways depending on at least one of said selected cooking program and said set amount of cooking

47. The method according to claim 45, including varying said parameters for at least one time section of said selected cooking program.

48. The method according to claim 45, including varying said parameters differently for different time sections of said selected cooking program.

49. The method according to claim 45, including varying different parameters for different time sections of said selected cooking program.

50. The method according to claim 45, including varying said parameters depending on a selected weight of food.

51. The method according to claim 45, including storing at least one of said modified parameters relevant to said selected cooking program and said amount of cooking relevant to said selected cooking program.

52. The method according to claim 45, including varying as a parameter at least one of a program duration and a desired temperature and a heating power and a weight of food and an operating mode.

53. The method according to claim 45, including displaying said set amount of cooking.

54. The method according to claim 53, including displaying said set amount of cooking at least one of numerically and graphically.
